(19) United States
(12) Patent Application Publication
(10) Pub. No.: US 2025/0377158 A1
(43) Pub. Date: Dec. 11, 2025

(54) TAG, CONTROL METHOD, AND CONTROL SYSTEM

(71) Applicant: Panasonic Intellectual Property Management Co., Ltd., Osaka (JP)

(72) Inventors: Mitsuhiro ASO, Osaka (JP); Gantetsu MATSUI, Hyogo (JP)

(21) Appl. No.: 18/876,984

(22) PCT Filed: Jun. 8, 2023
(86) PCT No.: PCT/JP2023/021372

§ 371 Date: Dec. 19, 2024

(30) Foreign Application Priority Data
Jun. 28, 2022 (JP) 2022-103928

(51) Int. Cl. F25D 29/00; G01K 11/12

(52) U.S. Cl. CPC F25D 29/005; G01K 11/12; F25D 2600/04; F25D 2700/16

(57) ABSTRACT

A tag includes: a temperature indicating material; and an identifier that presents identification information uniquely identifiable by appearance. A control method includes: capturing, with a camera, an image of a first food item that is a food item to be stored, or a food item stored, in an interior of a refrigerator to generate the image showing the tag, the tag being attached to the first food item; obtaining a temperature of the first food item by analyzing a color of the temperature indicating material included in the tag shown in the image generated; and generating control information to control cooling of the interior of the refrigerator by comparing the temperature obtained with an appropriate temperature range for the interior of the refrigerator, and transmitting the control information generated to the refrigerator.

### TECHNICAL FIELD

The present disclosure relates to a tag, a control method, and a control system.

### BACKGROUND ART

A technology for managing articles by matching identification information of a stored article with a photograph of the article inside a storage container has been available (e.g., see Patent Literature (PTL) 1).

### CITATION LIST

### Patent Literature

### [PTL 1]

Japanese Unexamined Patent Application Publication No. 2019-191663

### SUMMARY OF INVENTION

### Technical Problem

The present disclosure provides a tag, a control method, and a control system for appropriately managing food items to be stored in a refrigerator.

### Solution to Problem

The tag according to the present disclosure is a tag including: a temperature indicating material; and an identifier that presents identification information uniquely identifiable by appearance.

### Advantageous Effects of Invention

By using the tag according to the present disclosure, food items to be stored in a refrigerator can be appropriately managed.

### BRIEF DESCRIPTION OF DRAWINGS

FIG. 1 is a block diagram illustrating a functional configuration of a control system according to an embodiment.

FIG. 2 is a schematic diagram illustrating a first example of a tag according to the embodiment.

FIG. 3 is a schematic diagram illustrating a second example of the tag according to the embodiment.

FIG. 4 is a schematic diagram illustrating a third example of the tag according to the embodiment.

FIG. 5 is a schematic diagram illustrating a change in the third example of the tag according to the embodiment.

FIG. 6 is an explanatory diagram showing an example of temperature transition of a food item according to the embodiment.

FIG. 7 is an explanatory diagram illustrating a table showing edible periods of food items according to the embodiment.

FIG. 8 is an explanatory diagram illustrating first master data showing edible periods of food items according to the embodiment.

FIG. 9 is an explanatory diagram illustrating second master data showing edible periods of food items according to the embodiment.

FIG. 10 is an explanatory diagram illustrating third master data showing edible periods of food items according to the embodiment.

FIG. 11 is an explanatory diagram illustrating fourth master data showing edible periods of food items according to the embodiment.

FIG. 12 is an explanatory diagram illustrating a first example of an image displayed by a control system according to the embodiment.

FIG. 13 is an explanatory diagram illustrating a second example of an image displayed by the control system according to the embodiment.

FIG. 14 is a flow diagram showing processes of the control system according to the embodiment.

### DESCRIPTION OF EMBODIMENTS

The present inventor(s) have found that the following problems arise in the management of food items to be stored in a refrigerator, as described in the “Background Art” section.

Temperature control inside the refrigerator is performed based on a temperature detected by a temperature sensor installed inside the refrigerator. The temperature sensor detects the temperature of the air inside the refrigerator. Thus, after a food item with a relatively high temperature is stored inside the refrigerator, it takes some time for temperature rise to be detected by the temperature sensor. In addition, after the detection of the temperature rise as described above, it further takes some time for the temperature inside the refrigerator to return to its original level before the temperature rise, by the cooling function of the refrigerator.

During the period from when the temperature rise begins after the food item is stored inside the refrigerator until the temperature returns to its original level before the food item was stored inside the refrigerator, temperature of other food items may rise and such other food items stored inside the refrigerator may be damaged (in other words, may become inedible).

As just described, a problem with the temperature control inside the refrigerator that is performed based on the temperature sensor included in the refrigerator is that the temperature of the food items may rise as described above.

The present disclosure provides a tag, a control method, and a control system for appropriately managing food items to be stored in a refrigerator.

An aspect of the present disclosure provides a tag including: a temperature indicating material; and an identifier that presents identification information uniquely identifiable by appearance.

According to the aspect described above, both a temperature and the identification information, which are indicated by the tag, are simultaneously obtained by image analysis on an image showing the tag, which is obtained through image capturing. As an example, when the tag is attached to a food item to be stored in a refrigerator, cooling control of the refrigerator can be performed based on the temperature indicated by the tag. Thus, the tag allows for the appropriate management of the food item to be stored in the refrigerator.

The temperature indicating material may include a thermochromic ink.

According to the aspect described above, since the temperature indicating material includes the thermochromic ink, there is obtained an effect of being able to easily manufacture such a temperature indicating material by printing. Also, there is obtained an effect of being able to easily manufacture temperature indicating materials having various designs at low cost. Thus, the tag allows for the appropriate management of the food item to be stored in the refrigerator more easily.

The tag may contain no metal.

According to the aspect described above, since the tag contains no metal, the reflection of electromagnetic waves or the generation of sparks, which are caused by metal when a microwave oven operates, can be prevented from occurring, and therefore the tag can be used more safely. Thus, the tag allows for the appropriate management of the food item to be stored in the refrigerator more safely.

The tag may include an attachment part to be attached to a food item, or a container or packaging for the food item. Alternatively, the tag may be part of a container or packaging for a food item.

According to the aspect described above, since the tag is attached to the food item via the attachment part or is in contact with the food item as part of the container or packaging for the food item, the tag has a temperature approximately the same as that of the food item. As a result, the temperature of the food item can be obtained with higher accuracy through the image analysis on the image showing the tag. Thus, the tag allows for the appropriate management of the food item to be stored in the refrigerator by obtaining the temperature of the food item with higher accuracy.

The tag may further include an indicator that indicates a temperature predetermined as an upper limit temperature of a food item to be stored in an interior of a refrigerator.

According to the aspect described above, since the tag includes the indicator, a user can be reminded not to store, in the interior of the refrigerator, a food item with a temperature above the temperature predetermined as the upper limit temperature of the food item to be stored in the interior of the refrigerator. Thus, the tag allows for the appropriate management of the food item to be stored in the refrigerator while preventing a food item with a relatively high temperature from being stored in the refrigerator.

An aspect of the present disclosure provides a control method including: capturing, with a camera, an image of a first food item that is a food item to be stored, or a food item stored, in an interior of a refrigerator to generate the image showing the tag, the tag being attached to the first food item; obtaining a temperature of the first food item by analyzing a color of the temperature indicating material included in the tag shown in the image generated; and generating control information to control cooling of the interior of the refrigerator by comparing the temperature obtained with an appropriate temperature range for the interior of the refrigerator, and transmitting the control information generated to the refrigerator.

According to the aspect described above, the cooling control of the refrigerator can be performed based on the temperature of the food item to be stored in the refrigerator. Thus, the control method allows for the appropriate management of the food item to be stored in the refrigerator.

In the generating of the control information, when the temperature obtained is determined to be higher than the appropriate temperature range, control information to intensify cooling of the refrigerator may be generated.

According to the aspect described above, the cooling of the refrigerator is intensified when the temperature of the food item is higher than the appropriate temperature range. As a result, the temperature of the food item can be reduced faster and temperature rises in other food items stored in the interior of the refrigerator can be prevented or mitigated. Thus, by preventing or mitigating such temperature rises in the food items stored in the refrigerator, the control method allows for the appropriate management of the food items.

The cooling of the refrigerator may be continuously controlled by repeatedly performing the generating of the control information based on the capturing of the image of the first food item stored in the interior of the refrigerator, and the transmitting of the control information.

According to the aspect described above, since the cooling of the refrigerator is controlled continuously, a temperature rise in the food item stored in the interior of the refrigerator can be prevented or mitigated. Thus, by preventing or mitigating such a temperature rise in the food item stored in the refrigerator, the control method allows for the appropriate management of the food item.

The control method may include analyzing a position, in the interior of the refrigerator, of the tag shown in the image generated. In the generating of the control information, control information to intensify cooling at the position where the tag including the temperature indicating material that indicates a temperature higher than the appropriate temperature range is present may be generated.

According to the aspect described above, the position, in the interior of the refrigerator, of the food item having a temperature higher than the appropriate temperature range is used to intensify cooling at the position where the food item is present. As a result, the temperature of that food item can be reduced even faster, and temperature rises in other food items stored in the interior of the refrigerator can be prevented or mitigated. Thus, by preventing or mitigating such temperature rises in the food items stored in the refrigerator, the control method allows for the appropriate management of the food items.

The control method may include: obtaining the identification information presented by the identifier included in the tag shown in the image; generating, corresponding to the identification information, food information indicating a use-by date or a best-before date of the first food item to which the tag is attached; and performing presentation control to present the food information.

According to the aspect described above, such a use-by date or best-before date (also referred to as a use-by date or the like) for each food item is presented to a user. This makes the user aware of the use-by date or the like for each food item, thus obtaining an effect of promoting the effective use of the food item and preventing the waste of the food item from occurring. Thus, the control method allows for the appropriate management of the food item to be stored in the refrigerator while promoting the effective use of the food item and preventing the waste of the food item from occurring.

The control method may further include: obtaining, using the identification information, transition information that shows temperature transition of the first food item; adjusting the use-by date or the best-before date of the first food item using the transition information obtained; and presenting, in the presentation control, the food information using the use-by date adjusted or the best-before date adjusted.

According to the aspect described above, the use-by date or the like of the food item stored in the refrigerator is adjusted based on the temperature transition of the food item. When a food item having been stored in the refrigerator is left outside the refrigerator and then placed back into the refrigerator, for example, such adjustment allows the use-by date or the like to reflect the fact that the food item spoils faster, thus contributing to the safe consumption of the food item by the user. Therefore, the control method allows for the appropriate management of the food item stored in the refrigerator.

An aspect of the present disclosure provides a control system including: an imager that captures, with a camera, an image of a first food item that is a food item to be stored, or a food item stored, in an interior of a refrigerator to generate the image showing the tag, the tag being attached to the first food item; an analyzer that obtains a temperature of the first food item by analyzing a color of the temperature indicating material included in the tag shown in the image generated; and a controller that generates control information to control cooling of the interior of the refrigerator by comparing the temperature obtained with an appropriate temperature range for the interior of the refrigerator, and transmits the control information generated to the refrigerator.

According to the aspect described above, the control system has the same effects as the control method described above.

An embodiment will be described below in detail with reference to the drawings as appropriate. Note however that unnecessarily detailed descriptions may be omitted. For example, detailed descriptions of matters already well known or duplicate descriptions of substantially identical configurations may be omitted. This is to prevent the following description from becoming unnecessarily verbose and thereby facilitate the understanding of those skilled in the art.

The present inventor(s) provide the accompanying drawings and the following description only to enable those skilled in the art to fully understand the present disclosure. The present inventor(s) do not intend to limit the subject matters recited in the claims by the accompanying drawings and the following description.

### EMBODIMENT

In the present embodiment, a tag, a control method, and a control system for appropriately managing food items to be stored in a refrigerator will be described.

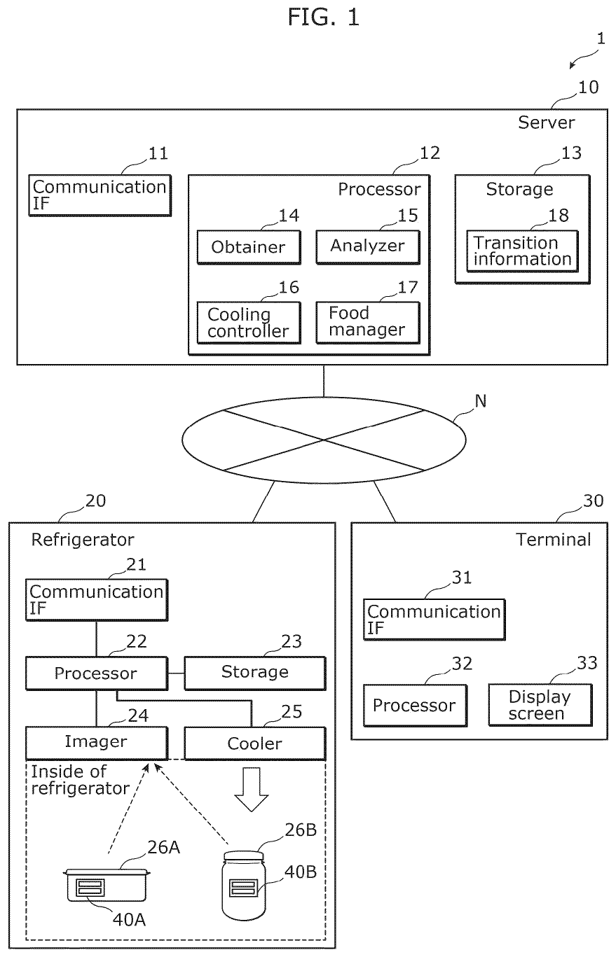

FIG. 1 is a block diagram illustrating a configuration of control system 1 according to the present embodiment.

As shown in FIG. 1, control system 1 includes server 10, refrigerator 20, and terminal 30. Such devices included in control system 1 are connected to be capable of being communicated with one another via network N.

Refrigerator 20 refrigerates food items stored inside the refrigerator. Here, a case in which food items 26A and 26B (also referred to as food items 26A, etc.) are stored inside refrigerator 20 will be described as an example. Food items 26A and 26B are provided with tags 40A and 40B (also referred to as tags 40A, etc.), respectively. Food items 26A, etc. are each correspond to a first food item. Note that the number of food items 26A, etc. is not limited to two, but may be any number that is greater than or equal to one.

The term “food item” generally refers to a food item in a form to be stored in refrigerator 20. More specifically, the term “food item” may refer to a food item itself (i.e., a food item without a container or packaging), or to a food item and a container with the food item stored inside, or to a food item and a packaging sheet with the food item packaged inside.

Note that “inside refrigerator 20” refers to the interior of a compartment included in refrigerator 20. More specifically, “inside refrigerator 20” may refer to, for example, the interior of a refrigerator compartment included in refrigerator 20 (with an appropriate temperature range of 2° C. to 5° C., for example), the interior of a freezer compartment included in refrigerator 20 (with an appropriate temperature range of −18° C. or lower, for example), or the interior of a vegetable compartment included in refrigerator 20 (with an appropriate temperature range of 3° C. to 8° C., for example).

Note that refrigerator 20 may be a refrigerator having a refrigerator compartment and a freezer compartment, or may further include another compartment (such as a chilled compartment or a vegetable compartment). Refrigerator 20 may also be a refrigerator having only a refrigerator compartment, or a refrigerator having only a freezer compartment (which may also be referred to as a freezer).

Such a compartment included in refrigerator 20 may include a door, for example, and can be opened and closed by the door. Alternatively, such a compartment included in refrigerator 20 may include a drawer, for example, and the compartment can be pulled out and pushed back by the drawer.

Tag 40A will be described below. Tag 40A refers to a tag used to uniquely identify food item 26A. Tag 40A is also used by server 10 to obtain the temperature of food item 26A, thus contributing to cooling control of refrigerator 20.

Since tag 40B is similar to tag 40A except that tag 40B is used for food item 26B, the description of tag 40B will be omitted.

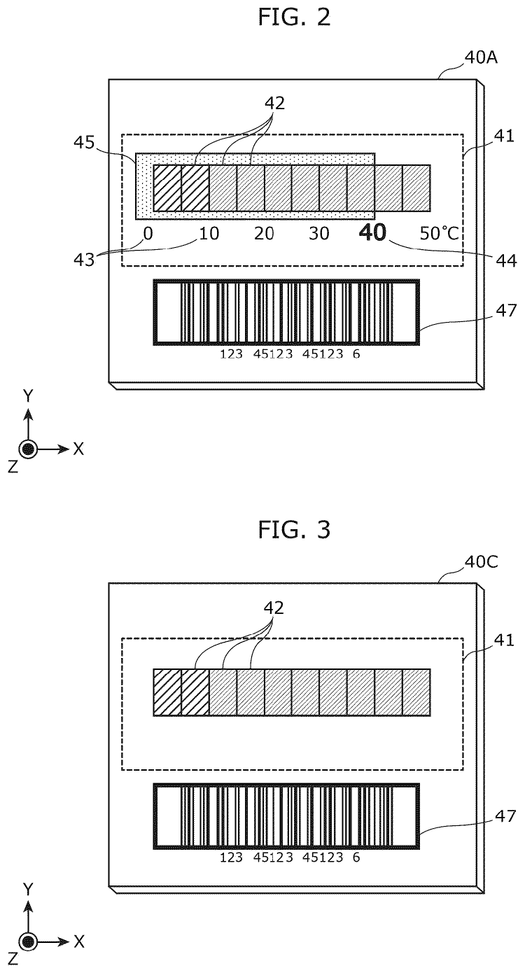

FIG. 2 is a schematic diagram illustrating a first example of tag 40A according to the present embodiment. Tag 40A will be described using an X-axis, a Y-axis, and a Z-axis shown in FIG. 2.

Tag 40A shown in FIG. 2 has a body in the form of a sheet parallel to an XY plane. For example, lengths in the X-axis and Y-axis directions are each about 1 cm to 10 cm, and a length (i.e., a thickness) in the Z-axis direction is a few millimeters or less. However, the lengths are not limited to these values.

As shown in FIG. 2, tag 40A includes temperature indicator 41 and identifier 47.

Temperature indicator 41 includes temperature indicating material 42 that changes color depending on the temperature. Temperature indicating material 42 is a reversible temperature indicating material that returns to its original color when the temperature returns to the original temperature after a color change.

By way of example, a plurality of temperature indicating materials 42 are arranged side by side in a direction parallel to the X-axis.

The plurality of temperature indicating materials 42 are configured as a whole to indicate temperature in a temperature range of 0° C. to 50° C., for example, including the appropriate temperature range for the interior of the refrigerator compartment. The plurality of temperature indicating materials 42 each correspond to a temperature range in increments of 5° C. in a direction in which an X-coordinate increases.

Each of the plurality of temperature indicating materials 42 is configured to change color in the corresponding temperature range. More specifically, each of the plurality of temperature indicating materials 42 is configured to take on: a first color at a temperature lower than the temperature range corresponding to that temperature indicating material 42; a second color at a temperature higher than the above-described temperature range; and the first color, the second color, or an intermediate color between the first color and the second color within the above-described temperature range. Here, the first color is different from the second color.

Temperature indicator 41 may also include indicators 43 that indicate the temperature ranges corresponding to temperature indicating materials 42 at positions on the negative side of the Y-axis relative to temperature indicating materials 42. Specifically, indicators 43 are indications of temperature scales such as “0° C.”, “5° C.”, “10° C.”, . . . , “50° C.”. The unit (i.e., “° C.”) may be omitted or some of the scales (e.g., “5° C.”, “15° C.”, etc.) may be omitted to the extent that such omission does not mislead users. Note that the color of characters in indicators 43 is not limited to black, but may be any color such as blue or red. Note that indicator 43 is not an essential element, and temperature indicator 41 may include no indicators 43.

In FIG. 2, temperature indicating material 42 among the plurality of temperature indicating materials 42 that is positioned on the most negative side of the X-axis corresponds to a temperature range of 0° C. to 5° C. Temperature indicating material 42 next to temperature indicating material 42 positioned on the most negative side of the X-axis corresponds to a temperature range of 5° C. to 10° C. Temperature indicating material 42 that is positioned on the most positive side of the X-axis corresponds to a temperature range of 45° C. to 50° C. In FIG. 2, “° C.” to be included in the temperature scales is omitted except for “50° C.”, and the indications of temperature scales with a units digit of 5 are also omitted.

In the case of tag 40A to be used in the interior of the freezer compartment, the plurality of temperature indicating materials 42 may be configured as a whole to indicate temperature in a temperature range (e.g., −20° C. to 10° C.) including the appropriate temperature range for the freezer compartment.

Indicator 43 may also be an indicator that indicates a temperature predetermined as an upper limit temperature (also referred to as a predetermined temperature) of a food item to be stored inside refrigerator 20. Specifically, indicators 43 may include at least one of indicator 44 or indicator 45.

Indicator 44 shows the temperature scale indicating the above-described predetermined temperature in a manner different from remaining indicators 43 among the plurality of indicators 43. In FIG. 2, indicator 44 is the indication of “40° C.” and shown in bold and in a larger size than the characters of remaining indicators 43. Note that the color of the characters in indicator 44 is not limited to black, but may be any color such as blue or red. Indicator 44 may be shown in a color different from that of the characters of remaining indicators 43.

Indicator 45 is a figure surrounding those of the plurality of temperature indicating materials 42 that correspond to the temperature range at or below the above-described predetermined temperature. Note that the shape of indicator 45 is not limited to a rectangle, but may be any figure. Also, the interior of indicator 45 may be filled with coloring or a dot pattern, for example.

Since indicators 43 include the indicator (at least one of indicator 44 or indicator 45) indicating the predetermined temperature, a user can be reminded not to store, inside the refrigerator, food item 26A with a temperature above the predetermined temperature.

Specifically, temperature indicating material 42 is made using a thermochromic ink, a synthetic resin with a thermochromic material mixed in, or cloth or paper made of fiber with a thermochromic material mixed in, for example.

When temperature indicating material 42 includes a thermochromic ink, temperature indicator 41 is manufactured by printing. Thus, there is obtained an effect of being able to easily manufacture temperature indicators 41 having various designs at low cost.

The case in which temperature indicator 41 includes the plurality of temperature indicating materials 42 has been described with reference to FIG. 2. However, temperature indicator 41 may be configured to include single temperature indicating material 42, and such single temperature indicating material 42 may be configured to indicate temperature by changing into a plurality of colors within a temperature range of 0° C. to 50° C., including the appropriate temperature range for the interior of the refrigerator compartment.

Identifier 47 presents identification information that is uniquely identifiable by appearance. With such identification information, a food item stored inside refrigerator 20 can be uniquely identified. The identification information may be identification information generally assigned to the product (e.g., a Japanese article number (JAN) code or a global trade item number (GTIN) code), or may be a code specified by a user in a manner that allows the food item to be uniquely identified within the range of food items stored inside refrigerator 20.

Although a case in which identifier 47 is a bar code is shown as an example, identifier 47 is not limited thereto. Identifier 47 may be a two-dimensional code (e.g., a QR code (registered trademark)), a color code, a character, a symbol, or a figure, for example. Identifier 47 may be formed on tag 40A through printing, for example, in the manufacturing process of tag 40A, or may be produced separately from tag 40A and then attached to tag 40A. In the latter case, identifier 47 with an adhesive applied onto its back surface may be attached to tag 40A by being affixed onto tag 40A.

When the outer shape of tag 40A is configured to be uniquely identifiable by appearance, the outer shape of tag 40A functions as identifier 47. More specifically, although FIG. 2 shows an example in which the outer shape of tag 40A is a rectangle, the outer shape of tag 40A may be a circle, a polygon, a figure with a concave-convex pattern in part or all of its periphery, or any desired figure. Such an outer shape of tag 40A functions as identifier 47.

Tag 40A may be configured without containing metal. This yields an effect of allowing food item 26A with attached tag 40A to be heated in a microwave oven. If tag 40A contains metal, the metal may cause reflection of electromagnetic waves, generation of sparks, and breakdown of a microwave oven when food item 26A with attached tag 40A is heated in the microwave oven.

Note that tag 40A may include an attachment part to be attached to food item 26A. The attachment part may be an adhesive applied to a surface of tag 40A that is opposite to the surface on which temperature indicator 41 and identifier 47 are provided. Alternatively, the attachment part may be a clip for clipping tag 40A onto food item 26A. Alternatively, tag 40A may be part of a container or packaging for food item 26A.

Note that a set of, for example, a bar code or a QR code and the outer shape of tag 40A, i.e., a combination of, for example, a bar code or a QR code and the outer shape of tag 40A, can also be used as identifier 47. Furthermore, if tag 40A is attached to a container or is part of a container, the outer shape of the container can also be used as identifier 47. Furthermore, a set of, for example, a bar code or a QR code and the outer shape of the container, or a set of, for example, a bar code or a QR code, the outer shape of tag 40A, and the outer shape of the container can also be used as identifier 47.

Examples of other forms of tag 40A according to the present embodiment will be described.

FIG. 3 is a schematic diagram illustrating tag 40C, which is a second example of the tag according to the present embodiment.

Tag 40C shown in FIG. 3 includes no indicators 43, which are included in tag 40A.

As with tag 40A, tag 40C shown in FIG. 3 is used by server 10 to obtain the temperature of food item 26A, thus contributing to cooling control of refrigerator 20.

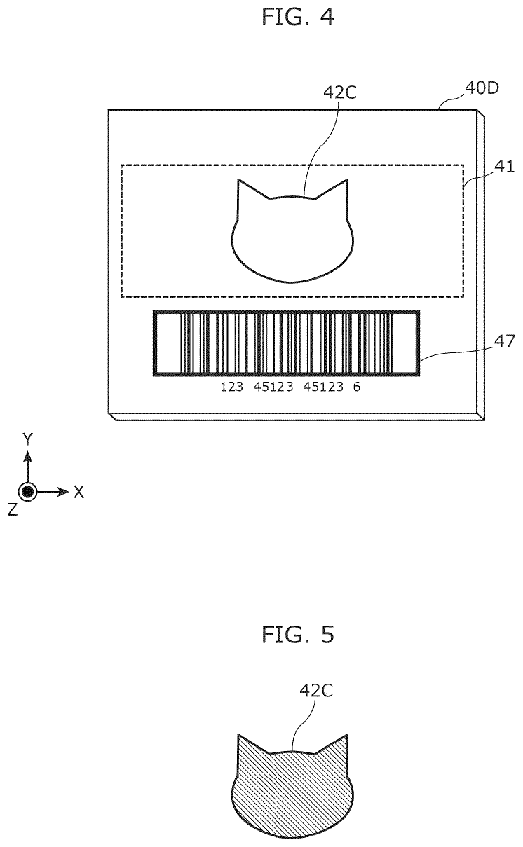

FIGS. 4 and 5 are schematic diagrams illustrating tag 40D, which is a third example of the tag according to the present embodiment.

Tag 40D shown in FIG. 4 includes temperature indicator 41 having single temperature indicating material 42C. For example, upon exceeding a predetermined temperature, temperature indicating material 42C changes into a color different from when having a temperature less than or equal to the predetermined temperature (see FIG. 5).

As with tag 40A, tag 40D shown in FIG. 4 is used by server 10 to obtain the temperature of food item 26A, thus contributing to cooling control of refrigerator 20.

Referring back to FIG. 1, functional components of refrigerator 20 will be described.

Refrigerator 20 includes communication interface (IF) 21, processor 22, storage 23, imager 24, and cooler 25.

Communication IF 21 is a communication interface that can be connected to network N. When refrigerator 20 communicates with other devices through network N, communication IF 21 transmits and receives communication packets to and from those devices. Communication IF 21 is a Wi-Fi (registered trademark) communication interface, for example.

Processor 22 controls operations of refrigerator 20. Processor 22 controls the operations of refrigerator 20 by executing a predetermined program using a memory (not shown).

Storage 23 is a storage device for storing information. Storage 23 is implemented by a hard disk drive (HDD) or a solid state drive (SSD), for example.

Imager 24 is a camera that captures an image of food items 26A, etc., which are food items to be stored, or food items stored, inside refrigerator 20, to generate the image showing food items 26A, etc. Imager 24 operates under the control by processor 22. The image generated by imager 24 shows tag 40A attached to food items 26A, etc., together with food items 26A, etc. Imager 24 transmits the generated image to server 10 via communication IF 21. Imager 24 may repeatedly capture and generate images. An interval between capturing and generating images is from about a few seconds to about a few minutes, for example, but the present disclosure is not limited thereto. When imager 24 repeatedly captures and generates images, imager 24 may transmit an image to server 10 each time such an image is generated, or may transmit a plurality of images to server 10 together.

Imager 24 is installed at a position, and in an orientation, allowing for capturing an image of a food item being placed into or taken out of refrigerator 20. For example, imager 24 is installed at an upper position in front of the refrigerator compartment of refrigerator 20 in an orientation facing downward. Alternatively, imager 24 is installed to the door of the refrigerator compartment of refrigerator 20 in an orientation facing the interior of refrigerator 20. Note that imager 24 may be installed inside or outside refrigerator 20. If a plurality of imagers 24 are provided, imager 24 may be installed in every compartment of refrigerator 20.

Cooler 25 is a cooling device that cools the interior of refrigerator 20. Cooler 25 operates under the control by processor 22.

Cooler 25 includes: a heat pump that takes in air inside the refrigerator and cools the air; a fan that circulates the cooled air; a vent through which the air cooled by the heat pump is blown into the interior of the refrigerator; and a controller that controls the heat pump, the fan, etc. Cooler 25 obtains control information from server 10 through communication IF 21 and controls the intensity of cooling of the interior of refrigerator 20 by controlling the operations of the heat pump and the fan according to the control information obtained from server 10 under the control by processor 22. Note that cooler 25 may include a plurality of vents. In such a case, cooler 25 may control the blowing of cold air for each of the plurality of vents according to the control information.

Terminal 30 includes communication IF 31, processor 32, and display screen 33.

Communication IF 31 is a communication interface that can be connected to network N. When terminal 30 communicates with other devices through network N, communication IF 31 transmits and receives communication packets to and from those devices. Communication IF 31 is a Wi-Fi communication interface or a cellular network communication interface, for example.

Processor 32 controls operations of terminal 30. Processor 32 controls the operations of terminal 30 by executing a predetermined program using a memory (not shown).

Display screen 33 is a display device that displays information. For example, display screen 33 displays, as an image, food information obtained from server 10 via communication IF 31. Note that a speaker, instead of display screen 33, may be provided to output the food information as sound. Alternatively, a presentation unit including at least one of the display device or the speaker may be provided instead of display screen 33.

Network N may include any communication line or network. Network N may include the Internet, a cellular phone carrier network, an Internet provider access network, or a public access network, for example.

Server 10 controls cooling of the interior of refrigerator 20 based on the temperatures of food items 26A, etc. stored inside refrigerator 20. Based on whether food items 26A, etc. are stored inside the refrigerator and temperature transition of food items 26A, etc., server 10 also controls the presentation, by terminal 30, of food information including use-by dates of the food items. Note that best-before dates of the food items may be used instead of the use-by dates. The same applies hereinafter.

Server 10 includes communication IF 11, processor 12, and storage 13.

Communication IF 11 is a communication interface that can be connected to network N. When the functional components included in server 10 communicate with other devices through network N, communication IF 11 transmits and receives communication packets to and from those devices. Communication IF 11 is an Ethernet (registered trademark) communication interface.

Processor 12 controls operations of server 10. Processor 12 controls the operations of server 10 by executing a predetermined program using a memory (not shown), thereby implementing obtainer 14, analyzer 15, cooling controller 16, and food manager 17.

Obtainer 14 obtains an image showing the interior of refrigerator 20 via communication IF 11.

By analyzing the image obtained by obtainer 14, analyzer 15 obtains identification information presented by identifier 47 included in tag 40A shown in that image. More specifically, by performing image analysis processing on the image obtained by obtainer 14, analyzer 15 identifies identifier 47 included in tag 40A shown in the image obtained by obtainer 14, and also obtains the identification information presented by identifier 47.

By analyzing the image obtained by obtainer 14, analyzer 15 also obtains the temperature indicated by tag 40A shown in that image. More specifically, by performing image analysis processing on the image obtained by obtainer 14, analyzer 15 identifies temperature indicator 41 included in tag 40A shown in the image obtained by obtainer 14, and also obtains the temperature indicated by tag 40A based on the color indicated by temperature indicator 41. Analyzer 15 has mapping information that maps a color indicated by temperature indicator 41 to a temperature of tag 40A. By referring to the mapping information, analyzer 15 obtains the temperature of tag 40A based on the color indicated by temperature indicator 41. The thus obtained temperature of tag 40A is also referred to as the “temperature indicated by tag 40A”. Analyzer 15 obtains the temperature indicated by tag 40A as the temperature of food item 26A. Note that analyzer 15 may obtain the temperature indicated by tag 40A independently from the temperature of food item 26A.

In addition to directly obtaining the temperature indicated by tag 40A based on the color indicated by temperature indicator 41, analyzer 15 can obtain the temperature indicated by tag 40A by using the area of a portion of temperature indicating materials 42 whose color has changed from the first color. Since the portion whose color has changed from the first color is determined using, for example, the luminance value, there is obtained an effect of facilitating the processing related to such determination.

Analyzer 15 may also retain, as transition information 18, the obtained temperature along with the time when the temperature was obtained. Furthermore, when food item 26A, which had been stored inside the refrigerator, was temporarily taken out of the refrigerator and then placed back into the refrigerator, analyzer 15 may estimate temperature of food item 26A during the period in which food item 26A was left outside the refrigerator (i.e., the period in which food item 26A was present outside the refrigerator) and add the estimated temperature to transition information 18. The temperature transition during the period in which food item 26A was left outside the refrigerator may be estimated, for example, as being the same as the temperature inside the refrigerator at a point in time when food item 26A was taken out of the refrigerator, gradually approaching room temperature after that point in time, and eventually reaching the room temperature.

Here, a temperature detected by a sensor included in an air conditioner installed in a space where refrigerator 20 is installed, for example, may be used as room temperature. Alternatively, a temperature detected by a sensor installed in the aforementioned space to measure room temperature may be used as room temperature. Alternatively, a temperature predetermined for each of seasons or different times of year may be used as room temperature. Alternatively, a predetermined temperature may be used as room temperature throughout the year regardless of the season or time of year.

The temperature transition as the temperature approaches the room temperature from the temperature inside the refrigerator can be calculated using known techniques based on the temperature difference between the temperature of food item 26A and the room temperature, and the heat capacity of food item 26A, for example. Transition information 18 will be described later in detail.

Analyzer 15 may also analyze the position, inside the refrigerator, of tag 40A shown in the image obtained by obtainer 14. When a plurality of imagers 24 are provided, analyzer 15 may analyze the position, inside the refrigerator, of tag 40A shown in the image obtained by obtainer 14, using the position at which imager 24 having captured the image is installed. Note that the position at which imager 24 having captured the image is installed can be obtained from information attached to the image in advance, or obtained based on a structure (e.g., the position and shape of a wall surface or a shelf inside the refrigerator) shown in the image.

If the image obtained by obtainer 14 shows a user who is placing food item 26A into the refrigerator or taking food item 26A out of the refrigerator, analyzer 15 may analyze the user. When a plurality of users are expected to use refrigerator 20, the user analysis is, for example, to identify which user among the plurality of users is shown in that image. The plurality of users using refrigerator 20 are a plurality of people living in a residence in which refrigerator 20 is installed, for example.

Cooling controller 16 generates control information for controlling the cooling of the interior of refrigerator 20 and transmits the generated control information to refrigerator 20. Specifically, cooling controller 16 generates such control information by comparing the temperature indicated by tag 40A, which has been obtained by analyzer 15, with an appropriate temperature range for the interior of refrigerator 20, and transmits the generated control information to refrigerator 20 via communication IF 11. The control information transmitted by cooling controller 16 is received by refrigerator 20 and used for cooling control that is performed by cooler 25 according to the control by processor 22 of refrigerator 20.

Specifically, the control information includes information for controlling the intensity of the cooling. For example, when the temperature inside refrigerator 20, which has been obtained by analyzer 15, is determined to be higher than the appropriate temperature range for the interior of the refrigerator, cooling controller 16 generates control information to intensify the cooling of refrigerator 20.

If imager 24 transmits, to server 10, images generated by repeatedly capturing an image of food items 26A, etc. stored inside refrigerator 20, cooling controller 16 can continuously control the cooling of refrigerator 20 by repeatedly obtaining a temperature inside refrigerator 20 using a received image, generating control information, and transmitting the control information.

When analyzer 15 analyzes the position of tag 40A, cooling controller 16 may generate control information to intensify cooling at the position where tag 40A having a temperature higher than the appropriate temperature range is present. More specifically, when cooler 25 is assumed to include a plurality of vents, such control information is control information to intensify cold air to be blown out of a vent among the plurality of vents that sends cold air toward the position at which tag 40A having a temperature higher than the appropriate temperature range is present (i.e., the vent relatively close to that position).

In the case where analyzer 15 analyzes dimensions of tag 40A, as the dimensions of tag 40A become larger, cooling controller 16 may generate control information to further intensify the cooling or control information to further increase duration in which the cooling is intensified.

Food manager 17 manages food items 26A, etc. to be stored inside the refrigerator. Such management includes management of the use-by date of food item 26A, for example. Specifically, corresponding to the identification information of each of food items 26A, etc. to be stored inside the refrigerator, food manager 17 generates food information indicating the use-by date of the food item. When generating the food information, food manager 17 obtains the use-by dates of food items 26A, etc. by referring to mapping information that maps a plurality of food items to edible periods predetermined for the plurality of food items. Food manager 17 may adjust such a use-by date by reference to transition information 18.

Food manager 17 also performs presentation control to cause terminal 30 to present the generated food information. Specifically, the presentation control includes transmitting the food information to terminal 30 and performing control to cause terminal 30 to display the food information as an image, for example.

Note that food manager 17 may adjust the use-by dates of food items 26A, etc. using transition information 18 generated by analyzer 15. In that case, the presentation control uses the adjusted use-by dates to control the presentation of the food information.

Storage 13 is a storage device that stores information. Storage 13 is implemented by a hard disk drive (HDD) or a solid state drive (SSD), for example. Storage 13 stores transition information 18. By way of example, transition information 18 is stored by analyzer 15 and read by food manager 17.

The arrangement of the functional components included in control system 1 shown in FIG. 1 is presented by way of example, but the functional components may be arranged differently.

For example, cooling controller 16, which is included in server 10, may be relocated to refrigerator 20. In this case, analyzer 15, which is included in server 10, may also be relocated to refrigerator 20. By doing so, without transmitting an image obtained by imager 24 to server 10, refrigerator 20 can, within refrigerator 20, generate control information from the image and control the cooling of the interior of the refrigerator. Such a configuration yields an effect of eliminating the influence of time lag in communication via network N.

Alternatively, obtainer 14, analyzer 15, cooling controller 16, and food manager 17 included in server 10 may be provided in refrigerator 20, and transition information 18 may be included in storage 23 of refrigerator 20, for example. Such a configuration yields an effect of simplifying the system configuration by eliminating the need for server 10, in addition to the aforementioned effect of eliminating the influence of the time lag. As a result, there is obtained an effect of reducing cost and power consumption.

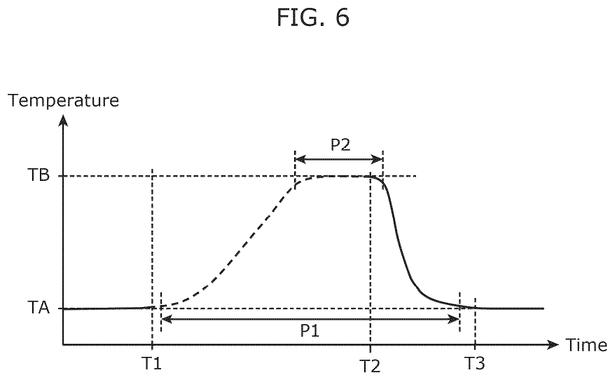

FIG. 6 is an explanatory diagram showing an example of temperature transition of food item 26A according to the present embodiment. Solid lines shown in FIG. 6 show an example of temperature transition of food item 26A obtained by analyzer 15 when food item 26A has been stored inside refrigerator 20 before time T1 and from time T2 onward. A broken line shown in FIG. 6 shows temperature transition of food item 26A estimated based on the temperature transition shown by the solid lines, the heat capacity of food item 26A, and the cooling capacity of refrigerator 20, for example. The obtaining of the temperature transition indicated by the broken line in FIG. 6 is not essential.

The temperature transition shown in FIG. 6 shows that the temperature of food item 26A has been continuously obtained before time T1 and that the temperature has consistently remained at temperature TA. Here, temperature TA is the temperature inside the refrigerator.

It is also shown that the temperature of food item 26A was unable to be obtained during the period from time T1 up to (but not including) time T2.

It is also shown that the temperature of food item 26A has been continuously obtained from time T2 onward and that the temperature was at temperature TB at time T2, gradually decreased after time T2, reached approximately temperature TA at time T3, and has consistently remained at temperature TA since time T3. Here, temperature TB refers to temperature outside the refrigerator, i.e., room temperature.

Food manager 17 adjusts the use-by dates of food items 26A, etc. based on the temperature transition.

For example, if the temperature of food item 26A has remained approximately at temperature TA, the use-by date of food item 26A can be set at a point in time when a predetermined edible period under refrigeration has elapsed, starting from the point in time when food item 26A was first stored inside the refrigerator.

If there is a period during which the temperature of food item 26A is higher than temperature TA (also referred to as a room temperature period), on the other hand, the use-by date of food item 26A under refrigeration is adjusted to be shorter. In such adjustment, the use-by date is adjusted to become shorter as the room temperature period becomes longer. The room temperature period may be set as period P1 during which the temperature of food item 26A is substantially higher than temperature TA (e.g., higher than a temperature that is 10% higher than the room temperature). If the temperature transition indicated by the broken line in FIG. 6 is obtained, the room temperature period may be set as period P2 during which the temperature of food item 26A is substantially equal to the room temperature (e.g., within ±10% of the room temperature).

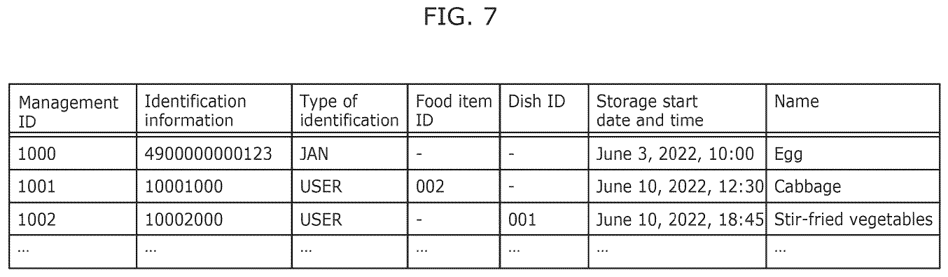

The management of food items 26A, etc. by food manager 17 will be described with reference to FIGS. 7 to 10.

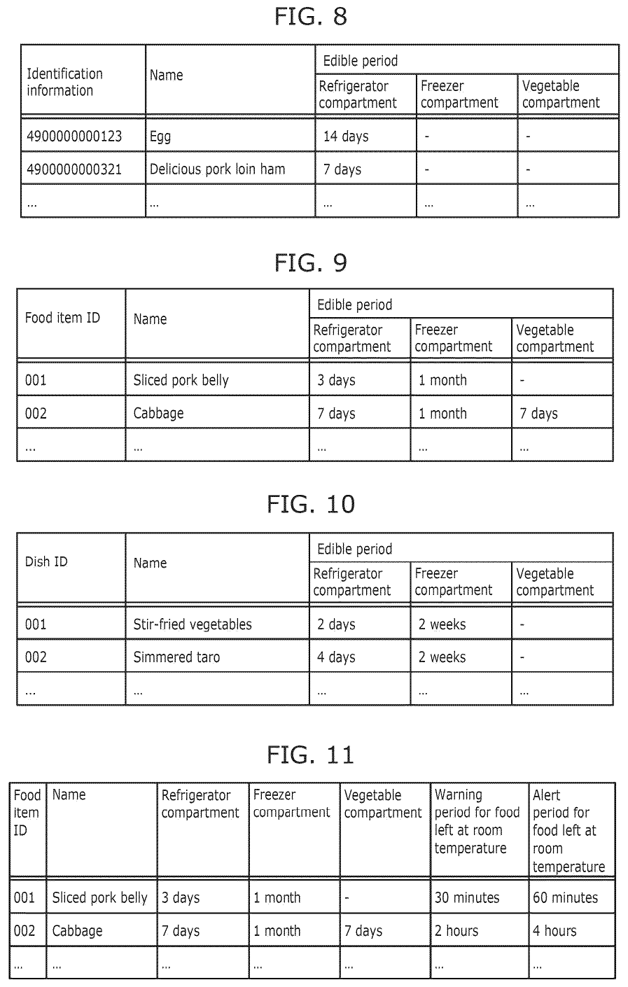

FIG. 7 is an explanatory diagram illustrating a first table showing edible periods of food items according to the present embodiment. The table shown in FIG. 7 is a main table used for the management of food items 26A, etc. Together with master data shown in FIGS. 8 to 10, the table shown in FIG. 7 is used for the management of food items 26A, etc. by food manager 17.

In the table shown in FIG. 7, corresponding to each of food items 26A, etc., the management ID, identification information, type of identification, food item ID, dish ID, storage start date and time, and name of the food item are shown.

The management ID refers to identification information with which the corresponding food item can be uniquely identified. The management ID is used for the management of the corresponding food item by food manager 17.

The identification information refers to identification information presented by identifier 47 included in tag 40A or the like attached to the corresponding food item. The identification information allows the corresponding food item stored inside refrigerator 20 to be uniquely identified. The identification information is identification information obtained by analyzer 15 when the corresponding food item is stored inside refrigerator 20.

The type of identification indicates a type of identification information. Specifically, examples of such a type of identification may include “JAN”, which indicates that the identification information is a JAN code, or “USER”, which indicates that the identification information is a code defined by the user.

The food item ID refers to identification information of the corresponding food item when that food item is obtained by the user in its original state (e.g., purchased at a food store).

The dish ID refers to identification information of the corresponding food item when that food item is a dish prepared by the user (what is called a “make-ahead dish”).

The storage start date and time refers to a date and time when the corresponding food item was first stored in refrigerator 20.

The name refers to a name of the corresponding food item. The name may be a name of the food item obtained, by means of image recognition, from an image captured when the corresponding food item is stored inside refrigerator 20, or may be a name of the corresponding food item entered by the user when that food item is stored inside refrigerator 20.

Note that the table shown in FIG. 7 may further include a user ID, an imager ID, or a compartment ID.

The user ID refers to identification data of a user who first placed the corresponding food item into refrigerator 20. The user ID is available when the user is analyzed by analyzer 15. The user ID may carry a meaning as the owner of the corresponding food item.

The imager ID refers to identification data of imager 24 that captured the image of the corresponding food item. When a plurality of imagers 24 are provided, imager IDs are set so that each of the plurality of imagers 24 can be uniquely identified. When cooler 25 includes a plurality of vents, the imager IDs are used by cooling controller 16 to control the blowing of cold air for each of the vents. More specifically, such an imager ID contributes to the control of intensifying cold air to be blown out of a vent that sends cold air toward the position at which the corresponding food item is present.

The compartment ID refers to identification data of a compartment that is included in refrigerator 20 and stores the corresponding food item. When there are a plurality of compartments, compartment IDs are set so that each of the plurality of compartments can be uniquely identified. When refrigerator 20 includes a plurality of compartments, such a compartment ID is used by cooling controller 16 to control the blowing of cold air. More specifically, the compartment ID contributes to the control of intensifying the cold air to be blown out of a vent in the compartment in which the corresponding food item is stored.

FIG. 8 is an explanatory diagram illustrating first master data showing edible periods of food items according to the present embodiment. The master data shown in FIG. 8 is master data that is predetermined and indicates, for each of JAN codes, the edible period of the corresponding food item. The master data shown in FIG. 8 is applied to food items that are each assigned a JAN code.

In the table shown in FIG. 8, corresponding to each of the food items, the identification information, name, and edible period of the food item are shown. The edible period refers to a standard edible period when the corresponding food item is preserved by being stored inside refrigerator 20 (more specifically, inside the refrigerator compartment, inside the freezer compartment, and inside the vegetable compartment), and such an edible period is a predetermined period.

FIG. 9 is an explanatory diagram illustrating second master data showing edible periods of food items according to the present embodiment. The master data shown in FIG. 9 is master data that is predetermined and indicates, for each of food item IDs, the edible period of the corresponding food item. The master data shown in FIG. 9 is applied when a name of a food item is manually entered by a user or when a name of a food item is determined through image recognition processing on an image.

In the table shown in FIG. 9, corresponding to each of the food items, the food item ID, name, and edible period of the food item are shown. Such an edible period includes edible periods when the corresponding food item is stored inside the refrigerator compartment, inside the freezer compartment, and inside the vegetable compartment.

FIG. 10 is an explanatory diagram illustrating third master data showing edible periods of food items according to the present embodiment. The master data shown in FIG. 10 is master data that is predetermined and indicates, for each of dish IDs, the edible period of the corresponding food item. The master data shown in FIG. 10 is applied when a name of a food item cooked by a user is manually entered or determined through image recognition processing on an image.

In the table shown in FIG. 10, corresponding to each of the food items, the identification information, name, and edible period of Such an edible period includes edible the food item are shown. periods when the corresponding food item is stored inside the refrigerator compartment, inside the freezer compartment, and inside the vegetable compartment.

Food manager 17 manages foods 26A, etc. by referring to the table and master data shown in FIGS. 7 to 10.

For example, for the food item with a management ID of 1000 in FIG. 7, the identification information is “4900000000123”, which is a JAN code, the name is “egg”, and the storage start date and time is “Jun. 3, 2022, 10:00”. By using the master data shown in FIG. 8 as master data containing the above-described identification information, which is a JAN code, the edible period of the “egg” when stored in the refrigerator compartment is found out to be 14 days.

For the food item with a management ID of 1002 in FIG. 7, the identification information is “10002000”, which is a code defined by a user, the name is “stir-fried vegetables”, and the storage start date and time is “Jun. 10, 2022, 18:45”. By using the master data shown in FIG. 10 as master data containing the above-described identification information, which is a code defined by the user, the edible period of the “stir-fried vegetables” is found out to be two days when stored in the refrigerator compartment and two weeks when stored in the freezer compartment.

The master data shown in FIGS. 8 to 10 may include a warning period for food left at room temperature and an alert period for food left at room temperature. The warning period for food left at room temperature refers to a period used to issue a warning for food item 26A or the like left at room temperature. Such a period is used to encourage the user to consume earlier the food item having been left outside the refrigerator beyond such a period. The alert period for food left at room temperature refers to a period used to issue an alert for food item 26A or the like left at room temperature. Such a period is used to notify the user of the risk of food poisoning for the food item having been left outside the refrigerator beyond such a period.

FIG. 11 is an explanatory diagram illustrating fourth master data showing edible periods of food items according to the present embodiment. The master data shown in FIG. 11 further includes warning periods for food left at room temperature and alert periods for food left at room temperature in addition to the master data shown in FIG. 9.

The master data shown in FIG. 11 shows that the warning period for food left at room temperature is 30 minutes and the alert period for food left at room temperature is 60 minutes for “sliced pork belly”.

Note that such a warning period for food left at room temperature and such an alert period for food left at room temperature may be set appropriately according to the season or the room temperature. The warning periods for food left at room temperature and the alert periods for food left at room temperature shown in FIG. 11 are given as an example when the room temperature is at 25° C. in the summer season.

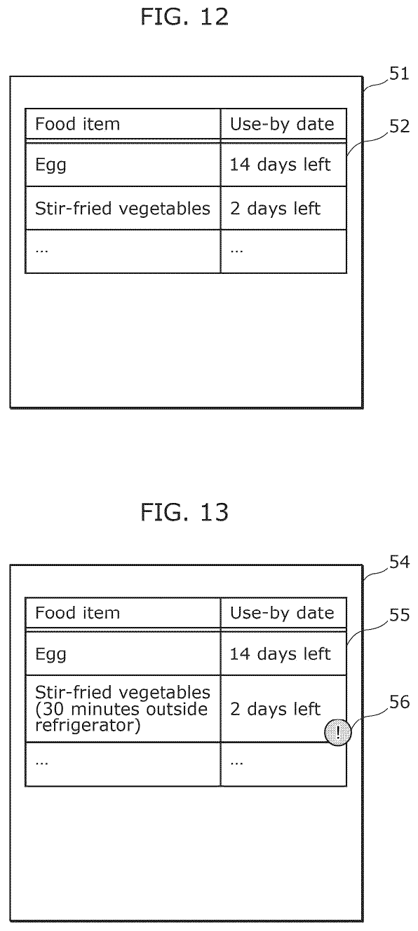

FIG. 12 is an explanatory diagram illustrating image 51, which is a first example of an image displayed by control system 1 according to the present embodiment. Image 51 is an example of an image displayed by terminal 30 under the control by server 10.

Image 51 includes table 52 that shows names of food items 26A, etc. stored inside refrigerator 20 and use-by dates of food items 26A, etc. in a manner corresponding to each other. Instead of table 52, an image showing the contents described above in a form other than the table may be used.

The column for food items in table 52 is generated from the column for names in the table shown in FIG. 7, and the column for use-by dates is generated from the present point in time and the predetermined edible periods.

Table 52 shows that food items 26A, etc. stored inside refrigerator 20 include an egg and stir-fried vegetables. Table 52 also shows that the use-by date of the egg is “14 days left” (i.e., 14 days starting from the present point in time, the same applies hereinafter) and the use-by date of the stir-fried vegetables is “2 days left”. Here, it is assumed that the egg is a raw egg purchased at a food store and the stir-fried vegetables are those stored inside refrigerator 20 after being cooked by the user.

FIG. 13 is an explanatory diagram illustrating image 54, which is a second example of an image displayed by control system 1 according to the present embodiment. As with image 51 (see FIG. 12), image 54 is an example of an image displayed by terminal 30 under the control by server 10. More specifically, image 54 is an image displayed, after the display of image 51, by terminal 30 when the stir-fried vegetables, which are one of the food items, were left outside the refrigerator for 30 minutes and then placed back into the refrigerator.

The column for food items and the column for use-by dates in Table 55 have the same meaning as in Table 52.

In Table 55, a character string “(30 minutes outside refrigerator)” is shown in the food item cell for the stir-fried vegetables. This character string indicates the fact that the stir-fried vegetables were left outside the refrigerator for 30 minutes.

Note that mark 56 may be displayed to draw the attention of the user to the food item that is relatively close to its use-by date. Such a food item relatively close to its use-by date is, for example, a food item whose use-by date is within “one day left”. By visually recognizing mark 56, the user can become aware that the food item with mark 56 must be consumed soon. This yields an effect of promoting the effective use of the food item and preventing the waste of the food item from occurring.

Note that the use-by date of the stir-fried vegetables may be adjusted to be shorter. For example, the use-by date of the stir-fried vegetables may be adjusted to “one day left”. This shows a result of the adjustment of the use-by date, which is performed because the stir-fried vegetables were left outside the refrigerator for 30 minutes, causing the temperature of the stir-fried vegetables to rise above temperature TA inside refrigerator 20 (more specifically, reach room temperature).

In the image displayed by terminal 30, which is shown in FIG. 12 or FIG. 13, only food items owned by the user of terminal 30 may be displayed. In other words, the image may not include any food item other than those owned by the user of terminal 30. Mark 56 in the aforementioned image may be configured to be displayed only in an image displayed on terminal 30 of the user who is the owner of the food item. The user who is the owner of the food item may be managed by the table shown in FIG. 7.

On the image displayed by terminal 30, which is shown in FIG. 12 or FIG. 13, terminal 30 may further be configured to modify a food item or a use-by date of a food item based on an operation by a user. Such a terminal that can modify a food item or a use-by date of a food item may be restricted only to terminal 30 of the user who is the owner of the food item.

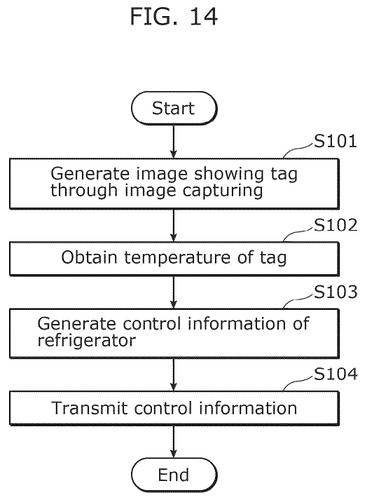

FIG. 14 is a flow diagram showing processes of control system 1 according to the present embodiment.

In step S101, refrigerator 20 captures, with a camera, an image of food item 26A (corresponding to the first food item), which is a food item to be stored or stored inside refrigerator 20, to generate the image showing tag 40A attached to food item 26A.

In step S102, server 10 obtains the temperature of food item 26A by analyzing colors of temperature indicating materials 42 included in tag 40A shown in the image generated by refrigerator 20.

In step S103, server 10 generates control information to control cooling of the interior of refrigerator 20 by comparing the temperature obtained in step S102 with the appropriate temperature range for the interior of refrigerator 20.

In step S104, server 10 transmits the control information generated in step S103 to refrigerator 20. Refrigerator 20 receives the transmitted control information and controls the cooling of the interior of the refrigerator according to the received control information.

Through the series of processes shown in FIG. 14, control system 1 can appropriately manage food items to be stored in the refrigerator.

As described above, according to the tag in the embodiment described above, both the temperature and the identification information, which are indicated by the tag, are simultaneously obtained by the image analysis on the image showing the tag, which is obtained through the image capturing. As an example, when the tag is attached to a food item to be stored in the refrigerator, the cooling control of the refrigerator can be performed based on the temperature indicated by the tag. Thus, the tag allows for the appropriate management of the food item to be stored in the refrigerator.

Since the temperature indicating material includes the thermochromic ink, there is obtained an effect of being able to easily manufacture such a temperature indicating material by printing. Also, there is obtained an effect of being able to easily manufacture temperature indicating materials having various designs at low cost. Thus, the tag allow for the appropriate management of the food item to be stored in the refrigerator more easily.

Since the tag contains no metal, the reflection of electromagnetic waves or the generation of sparks, which are caused by metal when a microwave oven operates, can be prevented from occurring, and therefore the tag can be used more safely. Thus, the tag allows for the appropriate management of the food item to be stored in the refrigerator more safely.

Since the tag is attached to the food item via the attachment part or is in contact with the food item as part of the container or packaging for the food item, the tag has a temperature approximately the same as that of the food item. As a result, the temperature of the food item can be obtained with higher accuracy through the image analysis on the image showing the tag. Thus, the tag allows for the appropriate management of the food item to be stored in the refrigerator by obtaining the temperature of the food item with higher accuracy.

Since the tag includes the indicator, a user can be reminded not to store, inside the refrigerator, a food item with a temperature above the temperature predetermined as the upper limit temperature of the food item to be stored inside the refrigerator. Thus, the tag allows for the appropriate management of the food item to be stored in the refrigerator while preventing a food item with a relatively high temperature from being stored in the refrigerator.

According to the control method in the embodiment described above, the cooling control of the refrigerator can be performed based on the temperature of the food item to be stored in the refrigerator. Thus, the control method allows for the appropriate management of the food item to be stored in the refrigerator.

The cooling of the refrigerator is intensified when the temperature of the food item is higher than the appropriate temperature range. As a result, the temperature of the food item can be reduced faster and temperature rises in other food items stored inside the refrigerator can be prevented or mitigated. Thus, by preventing or mitigating such temperature rises in the food items stored in the refrigerator, the control method allows for the appropriate management of the food items.

Since the cooling of the refrigerator is controlled continuously, a temperature rise in the food item stored inside the refrigerator can be prevented or mitigated. Thus, by preventing or mitigating such a temperature rise in the food item stored in the refrigerator, the control method allows for the appropriate management of the food item.

The position, inside the refrigerator, of the food item having a temperature higher than the appropriate temperature range is used to intensify cooling at the position where the food item is present.

As a result, the temperature of that food item can be reduced even faster, and temperature rises in other food items stored inside the refrigerator can be prevented or mitigated. Thus, by preventing or mitigating such temperature rises in the food items stored in the refrigerator, the control method allows for the appropriate management of the food items.

A use-by date or a best-before date (also referred to as a use-by date or the like) for each food item is presented to a user. This makes the user aware of the use-by date or the like for each food item, thus obtaining an effect of promoting the effective use of the food item and preventing the waste of the food item from occurring. Thus, the control method allows for the appropriate management of the food item to be stored in the refrigerator while promoting the effective use of the food item and preventing the waste of the food item from occurring.

The use-by date or the like of a food item stored in the refrigerator is adjusted based on the temperature transition of the food item. When a food item having been stored in the refrigerator is left outside the refrigerator and then placed back into the refrigerator, for example, such adjustment allows the use-by date or the like to reflect the fact that the food item spoils faster, thus contributing to the safe consumption of the food item by the user. Therefore, the control method allows for the appropriate management of the food item stored in the refrigerator.

The embodiment has been described above as an example of technologies in the present disclosure. The accompanying drawings and detailed description have been provided for the purpose of illustration.

Thus, the elements described in the accompanying drawings and the detailed description may include not only elements that are essential for solving the problem, but also elements that are not essential for solving the problem, in order to illustrate the implementation described above. Therefore, the fact that those non-essential elements are described in the accompanying drawings or the detailed description should not be readily construed as indicating that those elements are essential.

Since the embodiment described above is provided only to illustrate the technologies in the present disclosure, various modifications, substitutions, additions, omissions, etc. can be made within the scope of the claims or their equivalents.

### INDUSTRIAL APPLICABILITY

The present disclosure can be applied to a system for managing food items to be stored in a refrigerator.

### REFERENCE SIGNS LIST

1 control system
10 server
11, 21, 31 communication IF
12, 22, 32 processor
13, 23 storage
14 obtainer
15 analyzer
16 cooling controller
17 food manager
18 transition information
20 refrigerator
24 imager
25 cooler
26A, 26B food item
30 terminal
33 display screen
40A, 40B, 40C, 40D tag
41 temperature indicator
42, 42C temperature indicating material
43, 44, 45 indicator
47 identifier
51, 54 image
52, 55 table
56 mark
N network

1. A tag comprising:
a temperature indicating material; and
an identifier that presents identification information uniquely identifiable by appearance.

2. The tag according to claim 1,
wherein the temperature indicating material includes a thermochromic ink.

3. The tag according to claim 1,
wherein the tag contains no metal.

4. The tag according to claim 1,
wherein the tag includes an attachment part to be attached to a food item, or a container or packaging for the food item, or
the tag is part of a container or packaging for a food item.

5. The tag according to claim 1,
wherein the tag further includes an indicator that indicates a temperature predetermined as an upper limit temperature of a food item to be stored in an interior of a refrigerator.

6. A control method comprising:
capturing, with a camera, an image of a first food item that is a food item to be stored, or a food item stored, in an interior of a refrigerator to generate the image showing the tag according to claim 1, the tag being attached to the first food item;
obtaining a temperature of the first food item by analyzing a color of the temperature indicating material included in the tag shown in the image generated; and
generating control information to control cooling of the interior of the refrigerator by comparing the temperature obtained with an appropriate temperature range for the interior of the refrigerator, and transmitting the control information generated to the refrigerator.

7. The control method according to claim 6,
wherein in the generating of the control information, when the temperature obtained is determined to be higher than the appropriate temperature range, control information to intensify cooling of the refrigerator is generated.

8. The control method according to claim 6,
wherein the cooling of the interior of the refrigerator is continuously controlled by repeatedly performing the generating of the control information based on the capturing of the image of the first food item stored in the interior of the refrigerator, and the transmitting of the control information.

9. The control method according to claim 6, comprising:
analyzing a position, in the interior of the refrigerator, of the tag shown in the image generated,
wherein in the generating of the control information, control information to intensify cooling at the position where the tag including the temperature indicating material that indicates a temperature higher than the appropriate temperature range is present is generated.

10. The control method according to claim 6, comprising:
obtaining the identification information presented by the identifier included in the tag shown in the image;
generating, corresponding to the identification information, food information indicating a use-by date or a best-before date of the first food item to which the tag is attached; and
performing presentation control to present the food information.

11. The control method according to claim 10, further comprising:
obtaining, using the identification information, transition information that shows temperature transition of the first food item;
adjusting the use-by date or the best-before date of the first food item using the transition information obtained; and
presenting, in the presentation control, the food information using the use-by date adjusted or the best-before date adjusted.

12. A control system comprising:
an imager that captures, with a camera, an image of a first food item that is a food item to be stored, or a food item stored, in an interior of a refrigerator to generate the image showing the tag according to claim 1, the tag being attached to the first food item;
an analyzer that obtains a temperature of the first food item by analyzing a color of the temperature indicating material included in the tag shown in the image generated; and
a controller that generates control information to control cooling of the interior of the refrigerator by comparing the temperature obtained with an appropriate temperature range for the interior of the refrigerator, and transmits the control information generated to the refrigerator.

13. The tag according to claim 1,
wherein the tag includes an attachment part to be attached to a food item, or a container or packaging for the food item, or the tag is part of a container or packaging for a food item, and
the temperature indicating material is used to analyze a temperature of the food item, or the container or the packaging for the food item.
